(19) United States
(12) Patent Application Publication
(10) Pub. No.: US 2006/0210061 A1
(43) Pub. Date: Sep. 21, 2006

(54) Telephone handset and acoustic converter for one such telephone handset

(76) Inventors: Ulrich Hardebusch, Bocholt (DE); Jens Rauber, Bocholt (DE)

Correspondence Address: BELL, BOYD & LLOYD, LLC, P. O. BOX 1135, CHICAGO, IL, 60690-1135, US

(21) Appl. No.: 10/564,595

(22) PCT Filed: Jul. 17, 2003
(86) PCT No.: PCT/EP04/50430

§ 371 Date: Jan. 13, 2006

(30) Foreign Application Priority Data
Jul. 17, 2003 (DE) 103 32 580.8

(51) Int. Cl. H04M 1/00

(52) U.S. Cl. 379/444

(57) ABSTRACT

A wideband telephone handset is provided with an acoustic converter The acoustic converter is preferably a wideband acoustic converter and the membrane rear volume of the acoustic converter in the rear wall of the housing, thereof comprises openings which open towards the outside of the acoustic converter and from which noise can escape. The rear housing part of the telephone handset includes inner walls forming a type of channel through which the space up to the housing of the telephone handset is sealed in a soundproof manner around the openings of the rear wall of the housing of the acoustic converter. The rear housing part of the telephone handset has openings through which the noise escaping from the rear of the acoustic converter and conducted via the walls of the rear housing part of the telephone handset can be emitted from the telephone handset. These measures enable a low pitch to be increased, such that the wideband criterion is at least practically fulfilled in terms of the lower limiting frequency of the wideband transmission range.

The present disclosure relates to a telephone handset and an acoustic converter for making acoustic signals audible.

### BACKGROUND

Existing telephone handsets, such as corded telephones, have a relatively narrowly restricted transmission range. Such a transmission range is for example a range between approx. 300 Hz and 4 kHz. The reasons for the restriction to such a transmission range are the bandwidth of the transmission channel in telephony (analog and ISDN).

In recent times the trend has been towards wideband handsets of which the transmission range is expanded while fulfilling the same criteria which the previous handsets or their acoustic converters or their earpieces fulfilled. The expanded transmission range in this case covers at least approximately a frequency range of 160 Hz to 6.3 kHz.

Although standard wideband earpieces are inexpensive, in practice they do not fulfill the wideband criterion down to the lower end of the frequency range. Either very expensive acoustic converters are employed to fulfill this criterion or this deficiency is suffered by the user.

### SUMMARY

Under an exemplary embodiment, a telephone handset is disclosed such that, even if standard wideband acoustic converters are used, the wideband criterion relating to the lower end of the wideband frequency range is at least practically fulfilled or it is simply made possible to fully fulfill this criterion. Furthermore, a wideband acoustic converter is disclosed which can be used for the improved telephone handset.

Under one embodiment, the telephone handset includes design measures to allow an increase in low pitch to be achieved, through which the telephone handset at least practically fulfills the wideband criterion in relation to the lower end of the wideband frequency range. However, in any event, an improvement regarding the wideband tolerances is achieved so that, with the aid of smaller circuit technology, the wideband tolerances can be completely adhered to. The mechanical design and where necessary the additional circuit technology measures are of a less expensive nature, so that the new telephone handset is still inexpensive. In any event such a telephone handset is less expensive than if the effects obtained herein are achieved by a far more expensive acoustic converters.

Preferably, a converter is provided with additional openings at the rear so that the membrane rear volume is open to the outside of the converter so that sound can escape through these openings. This sound is simultaneously blocked by a soundproof construction from penetrating into the interior of the telephone handset. This is achieved by inner walls of the rear part of the housing of the telephone handset which guide the sound by forming a type of channel. For the sound to escape to the outside of the telephone handset, the rear part of the housing of the telephone handset also includes openings within the area of the channel cross-sectional surface. Overall a lowering of the pitch is achieved in this way without having a direct coupling to the microphone of the telephone handset. This avoids such problems as an impermissible reduction in acoustic stability and feedback in the telephone handset.

The acoustic converter is a low-cost acoustic converter which is provided with additional openings for sound to exit at its rear. Through these openings sound from the rear space volume of the acoustic converter can exit to the outside of the acoustic converter. Such an acoustic converter is suitable for use in a telephone handset of the type described above, with the wideband criterion relating to the lower frequency range of the wideband transmission range being at least practically fulfilled by a lowering of the pitch.

In an alternate embodiment, the internal walls of the rear part of the housing are in the form of a channel formed in a number of layers in order in this way to have a better soundproofing between the acoustic converter and the exit of sound to the outside the telephone handset in the direction of the inside of the telephone handset.

The channel-type internal walls are preferably embodied concentrically, i.e. forming a hollow cylinder. Hollow cylinders without bends are preferred.

In a further advantageous embodiment, the sealing point between the free end of the channel-type internal walls of the housing part of the telephone handset and the rear wall of the housing of the acoustic converter has additional material to make a soundproof seal. In this way undesired acoustic effects are prevented to a greater degree.

This additional material can be a foam material which can be in the form of a foam ring which takes account of the form of the cross-sectional surface of the channel path which is formed by the internal walls concerned.

The invention the acoustic converter is preferably embodied as a standard wideband acoustic converter.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 is a graph illustrating the sensitivity curves of telephone handsets with different acoustic converters, including an acoustic converter in accordance with a first embodiment, for operation in the wideband transmission range;

FIG. 2 illustrates a telephone handset in an exploded view with partly cutaway subcomponents; and

FIGS. 3 to 5 illustrate different designs of sound outlet openings on the housing of the telephone handset.

### DETAILED DESCRIPTION

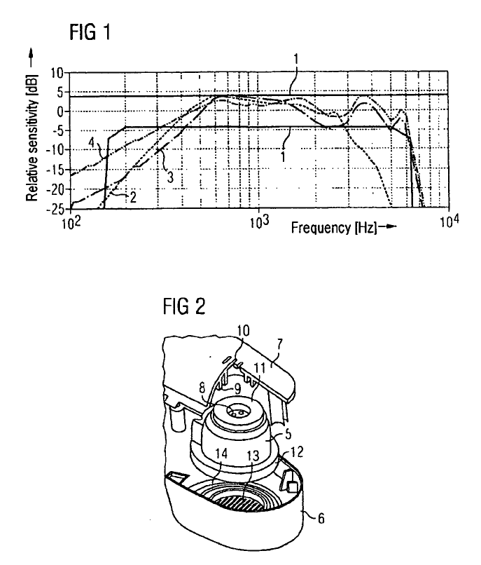

In the graph in FIG. 1 the frequency in the range of 100 Hz to 10 kHz is entered to the right. At the top the relative sensitivity in dB is entered. The sensitivity limits 1 are entered in the graph at the top and the bottom which are to be adhered to as well as possible for the operation of a wideband telephone handset. The wideband transmission range extends in this case from appr. 160 Hz to 6.3 kHz.

In the graph shown in FIG. 1, the sensitivity curves of three different telephone handsets are entered. Sensitivity curve 2 relates to a telephone handset in accordance with the prior art, in which a so-called narrowband acoustic converter is used. This telephone handset exhibits a steep fall-off in sensitivity towards the lower end of the wideband transmission range.

Furthermore, the sensitivity curve 3 shows a telephone handset according to the prior art, with a built-in wideband acoustic converter. This sensitivity curve features a significantly flatter drop in sensitivity towards the lower end of the wideband transmission range.

Finally the sensitivity curve 4 illustrates a telephone handset having a built-in inventive acoustic converter according to one embodiment. In this case the acoustic converter in principle corresponds to the acoustic converter to which sensitivity curve 3 is assigned, however with the additional mechanical detail that the acoustic converter according to the present disclosure features openings on the back through which sound can exit from the membrane rear volume of the acoustic converter. This sound is further transported to the outside by the telephone handset which features internal walls through which this sound is directed to the outside the telephone handset and which features openings in the housing of the telephone handset at the corresponding location.

The joint effect of these measures is a lowering in the pitch of approximately between 8 and 10 dB and a further flattening out of the drop-off in sensitivity towards the lower end of the wideband transmission range. Overall this at least practically achieves a sensitivity curve for the telephone handset which fulfills the wideband criterion at both the upper and at the lower end of the wideband transmission range at low cost. To completely fulfill the wideband tolerance range only a few other smaller circuit technology measures are necessary which can only be employed because of the fact that an increase in sensitivity of 8 to 10 dB has already been achieved by the constructional measures. With circuit technology measures alone it would not have been possible to realize this level of increase.

FIG. 2 shows a schematic layout of a telephone handset according to the disclosed embodiments.

The diagram shows an acoustic converter 5 or earpiece which is arranged between the lower shell of a telephone handset 6 and the upper shell of a telephone handset 7.

The acoustic converter 5 features openings 8 at the rear of its housing through which sound can escape from its membrane rear volume. This sound is directed to the outside of the telephone handset by means of internal walls 9 on the upper shell 7 of the telephone handset or on the back part of the housing of the telephone handset which form a type of channel and prevent the sound from entering the remaining part of the telephone handset. So that this sound can finally get out into the open air, the telephone handset upper shell 7 features openings 10 which can for example be embodied as exit slots, as illustrated in the present exemplary embodiment.

So that the sound is certain not to propagate itself inside the telephone handset, a soundproofing foam plastic ring 11 can be laid around the openings on the rear of the acoustic converter 5, which in the assembled state of the telephone handset fits between the free ends of the internal walls 9 of the telephone handset upper shell 7 and the rear side of the acoustic converter 5 and is clamped into this area.

So that the acoustic converter 5 in the telephone handset has a good hold and can also function overall, a further sealing ring is provided for completion of the telephone handset which is disposed between the speaking side of the acoustic converter 5 and the lower shell of the telephone handset 6 and which additionally holds the acoustic converter buffered in the assembled state of the telephone handset, and speech slots 13 are provided in the telephone handset lower shell 6 through which the user is able to speak into the acoustic converter 5. In accordance with the present exemplary embodiment sealing ribs 14 in the lower shell 6 of the telephone handset support soundproofing in the area in front of the acoustic converter 5.

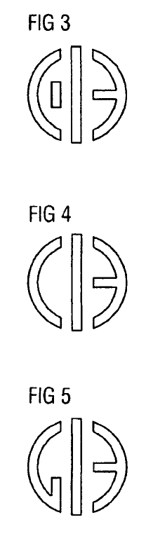

FIGS. 3 to 5 show designs for realizing slots which can be used instead of the simple outlet slots 10 on the telephone handset upper shell 7. The advantage of implementing the slots with these designs is that they can be used a recognizable sign that the telephone handset involved is a telephone handset using the configuration disclosed herein.

The particular slot geometry specified in this case is a stylized representation of the letters WB for wideband. Just as the two words “wide” and “band” are equal in length, everything in audio acoustics also revolves around the frequency of 1 kHz. In the logarithmic scale the lower limit frequency (160 Hz) lies at the same distance from the 1 kHz midpoint as the upper limit frequency of 6.3 kHz.

It can be said in particular with regard to the slot geometry in accordance with FIG. 3 that if this geometry is divided in the middle of the vertical bar, the two halves thus obtained feature “black sections” or sound passage sections of equal size. This is also the case if the slot geometry is divided on the diameter turned through 90°.

With regard to the slot geometry shown in FIG. 4 it can especially be said that the letters WB are easier to make out in this version. The complete circle symbolizes the letter W, while the semicircle on the right symbolizes the letter B.

With regard to the slot geometry shown in FIG. 5 it can especially be said that the left half symbolizes the letter W whereas the right half symbolizes the letter B.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-5. (canceled)

6. An acoustic converter for a portable device, comprising:
a housing, comprising a membrane rear volume;
an opening structure, located on the membrane rear volume;
internal walls, located on a rear wall of the device, wherein the internal walls form an acoustic channel through which sound is directed to the opening structure; and
an acoustical blocking element, located over the opening structure, wherein the acoustical blocking element forms an acoustic seal between the opening structure and the rear wall.

7. The acoustic converter according to claim 6, wherein the portable device is a telephone

8. The acoustic converter according to claim 6, wherein the internal walls comprise at least a single layer.

9. The acoustic converter according to claim 6, wherein the internal walls are formed concentrically.
